(19) United States
(12) Patent Application Publication
(10) Pub. No.: US 2013/0254202 A1
(43) Pub. Date: Sep. 26, 2013

(54) PARALLELIZATION OF SYNTHETIC EVENTS WITH GENETIC SURPRISAL DATA REPRESENTING A GENETIC SEQUENCE OF AN ORGANISM

(71) Applicants: Robert R. Friedlander, Southbury, CT (US); James R. Kraemer, Santa Fe, NM (US)

(72) Inventors: Robert R. Friedlander, Southbury, CT (US); James R. Kraemer, Santa Fe, NM (US)

(73) Assignee: International Business Machines Corporation, Armonk, NY (US)

(21) Appl. No.: 13/562,714

(22) Filed: Jul. 31, 2012

Related U.S. Application Data
(63) Continuation-in-part of application No. 13/557,631, filed on Jul. 25, 2012.
Application No. 13/557,631 is a continuation-in-part of application No. 13/428,146, filed on Mar. 23, 2012.
Application No. 13/428,146 is a continuation-in-part of application No. 13/428,339, filed on Mar. 23, 2012.

(51) Int. Cl. G06F 17/30

(52) U.S. Cl. 707/737; 707/E17.089; 707/E17.061

(57) ABSTRACT

A method, system, and computer program product for parallelization of updating synthetic events with genetic surprisal data comprising dividing the synthetic event into cohort parts and assigning the cohort parts to one of a plurality of computer processing elements. Within each processing element: searching data records of patients for genetic surprisal data; generating a cluster comprising a centroid by populating the cluster based on all of the matches of the data records; calculating a new centroid for each cluster; calculating a Euclidean distance in multiple dimensions for each match of data records to the new centroid for each cluster; reassigning each match of data to the new centroid of each cluster based on the shortest calculated Euclidean distance to the new centroid for each cluster; and determining at least one cohort part from the clusters and recombining the cohort parts into updated synthetic events based on the metadata.

### CROSS-REFERENCE TO RELATED APPLICATIONS

This application is a continuation-in-part of application Ser. No. 13/557,631, filed Jul. 25, 2012, entitled “CREATING SYNTHETIC EVENTS USING GENETIC SURPRISAL DATA REPRESENTING GENETIC SEQUENCE OF AN ORGANISM WITH AN ADDITION OF CONTEXT”, which was a continuation-in-part of pending patent application Ser. No. 13/428,146, filed Mar. 23, 2012, entitled “SURPRISAL DATA REDUCTION OF GENETIC DATA FOR TRANSMISSION, STORAGE AND ANALYSIS” and of copending application Ser. No. 13/428,339, filed Mar. 23, 2012, entitled “PARALLELIZATION OF SURPRISAL DATA REDUCTION AND GENOME CONSTRUCTION FROM GENETIC DATA FOR TRANSMISSION, STORAGE AND ANALYSIS”. The aforementioned applications are hereby incorporated herein by reference.

### BACKGROUND

The present invention relates to synthetic events, and more specifically to parallelization of synthetic events with genetic surprisal data representing a genetic sequence of an organism.

Often times during analysis, a sequence of an organism is compared to a reference genome of the organism. Depending on the number of bases and length of the genome, the comparison can take a significant amount of time, especially when being carried out by only one computer processor.

Similarly, the generation of synthetic events which comprise cohorts also takes a significant amount of time, especially when carried out by only one computer processor. A cohort is a group of individuals, machines, components, or modules identified by a set of one or more common characteristics. This group is studied over a period of time as part of a scientific study. A cohort may be studied for medical treatment, engineering, manufacturing, or for any other scientific purpose. A treatment cohort is a cohort selected for a particular action or treatment.

A control cohort is a group selected from a population that is used as the control. The control cohort is observed under ordinary conditions while another group is subjected to the treatment or other factor being studied. The data from the control group is the baseline against which all other experimental results must be measured. For example, a control cohort in a study of medicines for colon cancer may include individuals selected for specified characteristics, such as gender, age, physical condition, or disease state that do not receive the treatment.

The control cohort is used for statistical and analytical purposes. Particularly, the control cohorts are compared with action or treatment cohorts to note differences, developments, reactions, and other specified conditions. Control cohorts are heavily scrutinized by researchers, reviewers, and others that may want to validate or invalidate the viability of a test, treatment, or other research. If a control cohort is not selected according to scientifically accepted principles, an entire research project or study may be considered of no validity, wasting large amounts of time and money. In the case of medical research, selection of a less than optimal control cohort may prevent proving the efficacy of a drug or treatment or incorrectly rejecting the efficacy of a drug or treatment. In the first case, billions of dollars of potential revenue may be lost. In the second case, a drug or treatment may be necessarily withdrawn from marketing when it is discovered that the drug or treatment is ineffective or harmful, leading to losses in drug development, marketing, and even possible law suits.

Control cohorts are typically manually selected by researchers. Manually selecting a control cohort may be difficult for various reasons. For example, a user selecting the control cohort may introduce bias. Justifying the reasons, attributes, judgment calls, and weighting schemes for selecting the control cohort may be very difficult. Unfortunately, in many cases, the results of difficult and prolonged scientific research and studies may be considered unreliable or unacceptable requiring that the results be ignored or repeated. As a result, manual selection of control cohorts is extremely difficult, expensive, and unreliable.

### SUMMARY

According to one embodiment of the present invention, a method of parallelization of updating synthetic events with genetic surprisal data representing a genetic sequence of an organism. The method comprising: a computer receiving a synthetic event and associated metadata from a user, wherein the metadata comprises at least one genetic surprisal data attribute; the computer dividing the synthetic event into cohort parts and assigning the cohort parts and associated synthetic event metadata to one of the plurality of computer processing elements. Within each processing element: searching data records of patients for genetic surprisal data and storing matches of the data records in a repository; generating a cluster comprising a centroid by populating the cluster based on all of the matches of the data records; calculating a new centroid for each cluster; calculating a Euclidean distance in multiple dimensions for each match of data records to the new centroid for each cluster; reassigning each match of data to the new centroid of each cluster based on the shortest calculated Euclidean distance to the new centroid for each cluster; and determining at least one cohort part, a control cohort or a treatment cohort, from the clusters, and based on the associated metadata from the user and storing the at least one cohort part in a repository. The computer retrieving the cohort parts from the repository and recombining the cohort parts into updated synthetic events based on the metadata and storing the updated synthetic events in the repository.

According to another embodiment of the present invention, a method of parallelization of creating synthetic events with genetic surprisal data representing a genetic sequence of an organism. The method comprising: a computer retrieving data records of patients to be searched for synthetic events; the computer receiving a plurality of synthetic events and associated metadata from a user, wherein the metadata comprises at least one genetic surprisal data attribute; and the computer dividing the plurality of synthetic events into single synthetic events and assigning the single synthetic event and associated synthetic event metadata to one of the plurality of computer processing elements. Within each processing element, searching data records of patients for genetic surprisal data and storing matches of the data records in a repository; generating a cluster comprising a centroid by populating the cluster based on all of the matches of the data records; calculating a new centroid for each cluster; calculating a Euclidean distance in multiple dimensions for each match of data records to the new centroid for each cluster; reassigning each match of data to the new centroid of each cluster based on the shortest calculated Euclidean distance to the new centroid for each cluster; determining at least two cohorts, a control cohort and a treatment cohort, from the clusters, and based on the associated metadata from the user and storing the at least two cohorts in a repository; and retrieving any other data based on the associated metadata of the synthetic event and combining the other data retrieved with the at least two cohorts to form a synthetic event and storing the synthetic event in the repository.

According to another embodiment of the present invention, a computer program product for parallelization of updating synthetic events with genetic surprisal data representing a genetic sequence of an organism. The computer program product comprising: one or more computer-readable, tangible storage devices; program instructions, stored on at least one of the one or more storage devices, to receive a synthetic event and associated metadata from a user, wherein the metadata comprises at least one genetic surprisal data attribute; program instructions, stored on at least one of the one or more storage devices, to divide the synthetic event into cohort parts and assign the cohort parts and associated synthetic event metadata to one of the plurality of computer processing elements. Within each processing element, program instructions, stored on at least one of the one or more storage devices, to: search data records of patients for genetic surprisal data and store matches of the data records in a repository; generate a cluster comprising a centroid by populating the cluster based on all of the matches of the data records; calculate a new centroid for each cluster; calculate a Euclidean distance in multiple dimensions for each match of data records to the new centroid for each cluster; reassign each match of data to the new centroid of each cluster based on the shortest calculated Euclidean distance to the new centroid for each cluster; and determine at least one cohort part, a control cohort or a treatment cohort, from the clusters, and based on the associated metadata from the user and store the at least one cohort part in a repository; program instructions, stored on at least one of the one or more storage devices, to retrieve the cohort parts from the repository and recombine the cohort parts into updated synthetic events based on the metadata and store the updated synthetic events in the repository.

According to another embodiment of the present invention, a computer program product for parallelization of creating synthetic events with genetic surprisal data representing a genetic sequence of an organism. The computer program product comprising: program instructions, stored on at least one of the one or more storage devices, to retrieve data records of patients to be searched for synthetic events; program instructions, stored on at least one of the one or more storage devices, to receive a plurality of synthetic events and associated metadata from a user, wherein the metadata comprises at least one genetic surprisal data attribute; and program instructions, stored on at least one of the one or more storage devices, to divide the plurality of synthetic events into single synthetic events and assign the single synthetic event and associated synthetic event metadata to one of the plurality of computer processing elements. Within each processing element, program instructions, stored on at least one of the one or more storage devices, to: search data records of patients for genetic surprisal data and store matches of the data records in a repository; generate a cluster comprising a centroid by populating the cluster based on all of the matches of the data records; calculate a new centroid for each cluster; calculate a Euclidean distance in multiple dimensions for each match of data records to the new centroid for each cluster; reassign each match of data to the new centroid of each cluster based on the shortest calculated Euclidean distance to the new centroid for each cluster; determine at least two cohorts, a control cohort and a treatment cohort, from the clusters, and based on the associated metadata from the user and store the at least two cohorts in a repository; and retrieve any other data based on the associated metadata of the synthetic event and combine the other data retrieved with the at least two cohorts to form a synthetic event and store the synthetic event in the repository.

According to another embodiment of the present invention, a system for parallelization of updating synthetic events with genetic surprisal data representing a genetic sequence of an organism. The system comprising: one or more processors, one or more computer-readable memories and one or more computer-readable, tangible storage devices; program instructions, stored on at least one of the one or more storage devices for execution by at least one of the one or more processors via at least one of the one or more memories, to receive a synthetic event and associated metadata from a user, wherein the metadata comprises at least one genetic surprisal data attribute; program instructions, stored on at least one of the one or more storage devices for execution by at least one of the one or more processors via at least one of the one or more memories, to divide the synthetic event into cohort parts and assign the cohort parts and associated synthetic event metadata to one of the plurality of computer processing elements. Within each processing element, program instructions, stored on at least one of the one or more storage devices for execution by at least one of the one or more processors via at least one of the one or more memories, to: search data records of patients for genetic surprisal data and store matches of the data records in a repository; generate a cluster comprising a centroid by populating the cluster based on all of the matches of the data records; calculate a new centroid for each cluster; calculate a Euclidean distance in multiple dimensions for each match of data records to the new centroid for each cluster; reassign each match of data to the new centroid of each cluster based on the shortest calculated Euclidean distance to the new centroid for each cluster; and determine at least one cohort part, a control cohort or a treatment cohort, from the clusters, and based on the associated metadata from the user and store the at least one cohort part in a repository; program instructions, stored on at least one of the one or more storage devices for execution by at least one of the one or more processors via at least one of the one or more memories, to retrieve the cohort parts from the repository and recombine the cohort parts into updated synthetic events based on the metadata and store the updated synthetic events in the repository.

According to another embodiment of the present invention, a system for parallelization of creating synthetic events with genetic surprisal data representing a genetic sequence of an organism. The system comprising: program instructions, stored on at least one of the one or more storage devices for execution by at least one of the one or more processors via at least one of the one or more memories, to retrieve data records of patients to be searched for synthetic events; program instructions, stored on at least one of the one or more storage devices for execution by at least one of the one or more processors via at least one of the one or more memories, to receive a plurality of synthetic events and associated metadata from a user, wherein the metadata comprises at least one genetic surprisal data attribute; and program instructions, stored on at least one of the one or more storage devices for execution by at least one of the one or more processors via at least one of the one or more memories, to divide the plurality of synthetic events into single synthetic events and assign the single synthetic event and associated synthetic event metadata to one of the plurality of computer processing elements. Within each processing element, program instructions, stored on at least one of the one or more storage devices for execution by at least one of the one or more processors via at least one of the one or more memories, to: search data records of patients for genetic surprisal data and store matches of the data records in a repository; generate a cluster comprising a centroid by populating the cluster based on all of the matches of the data records; calculate a new centroid for each cluster; calculate a Euclidean distance in multiple dimensions for each match of data records to the new centroid for each cluster; reassign each match of data to the new centroid of each cluster based on the shortest calculated Euclidean distance to the new centroid for each cluster; determine at least two cohorts, a control cohort and a treatment cohort, from the clusters, and based on the associated metadata from the user and store the at least two cohorts in a repository; and retrieve any other data based on the associated metadata of the synthetic event and combine the other data retrieved with the at least two cohorts to form a synthetic event and store the synthetic event in the repository.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of data parallelization of surprisal data reduction of genetic data for transmission, storage, and analysis according to an illustrative embodiment.

FIGS. 3-4 show a flowchart of a method of data parallelization of synthetic events with surprisal data attributes using genetic surprisal data representing a genetic sequence of an organism according to an illustrative embodiment.

FIG. 5-6 show a flowchart of a method of data parallelization of creating synthetic events with surprisal data attributes using genetic surprisal data representing a genetic sequence of an organism according to an illustrative embodiment.

FIG. 7 shows a schematic of a parallelization computer scheme of an embodiment of the present invention.

FIG. 8 shows block diagram of a system for generating control cohorts in accordance with an illustrative embodiment.

FIGS. 9A-9B are graphical illustrations of clustering in accordance with an illustrative embodiment.

FIG. 10 illustrates internal and external components of a client computer and a server computer in which illustrative embodiments may be implemented.

### DETAILED DESCRIPTION

The illustrative embodiments of the present invention recognize that the difference between the genetic sequence from two humans is about 0.1%, which is one nucleotide difference per 1000 base pairs or approximately 3 million nucleotide differences. The difference may be a single nucleotide polymorphism (SNP) (a DNA sequence variation occurring when a single nucleotide in the genome differs between members of a biological species), or the difference might involve a sequence of several nucleotides. The illustrative embodiments recognize that most SNPs are neutral but some, approximately 3-5%, are functional and influence phenotypic differences between species through alleles. Furthermore, approximately 10 to 30 million SNPs exist in the human population, of which at least 1% are functional. The illustrative embodiments also recognize that with the small amount of differences present between the genetic sequence from two humans, the “common” or “normally expected” sequences of nucleotides can be compressed out or removed to arrive at “surprisal data”-differences of nucleotides which are “unlikely” or “surprising” relative to the common sequences. The dimensionality of the data reduction that occurs by removing the “common” sequences is 10³, such that the number of data items and, more important, the interaction between nucleotides, is also reduced by a factor of approximately 10³—that is, to a total number of nucleotides remaining on the order of 10³. The illustrative embodiments also recognize that by identifying what sequences are “common” or provide a “normally expected” value within a genome, and knowing what data is “surprising” or provides an “unexpected value” relative to the normally expected value.

The illustrative embodiments provide a computer implemented method, apparatus, and computer usable program code for data parallelization of synthetic events with surprisal data attributes using genetic surprisal data representing a genetic sequence of an organism with addition of context and optimization of genetic surprisal data control cohorts. Context is herein defined to be any information that can be used to characterize the situation of an entity. Results of a clustering process are used to calculate an objective function for selecting an optimal control cohort. A cohort is a group of individuals with common characteristics. Frequently, cohorts are used to test the effectiveness of medical treatments. Treatments are processes, medical procedures, drugs, actions, lifestyle changes, or other treatments prescribed for a specified purpose. A control cohort is a group of individuals that share a common characteristic that does not receive the treatment. The control cohort is compared against individuals or other cohorts that received the treatment to statistically prove the efficacy of the treatment.

The illustrative embodiments provide an automated method, apparatus, and computer usable program code for selecting individuals and their genetic surprisal data for a control cohort through data parallelization. To demonstrate a cause and effect relationship, an experiment must be designed to show that a phenomenon occurs after a certain treatment is given to a subject and that the phenomenon does not occur in the absence of the treatment. A properly designed experiment generally compares the results obtained from a treatment cohort against a control cohort which is selected to be practically identical. For most treatments, it is often preferable that the same number of individuals is selected for both the treatment cohort and the control cohort for comparative accuracy. The classical example is a drug trial. The cohort or group receiving the drug would be the treatment cohort, and the group receiving the placebo would be the control cohort. The difficulty is in selecting the two cohorts to be as near to identical as possible while not introducing human bias.

The illustrative embodiments provide an automated method, apparatus, and computer usable program code for selecting a genetic surprisal data control cohort. Because the features in the different embodiments are automated, the results are repeatable and introduce minimum human bias. The results are independently verifiable and repeatable in order to scientifically certify treatment results.

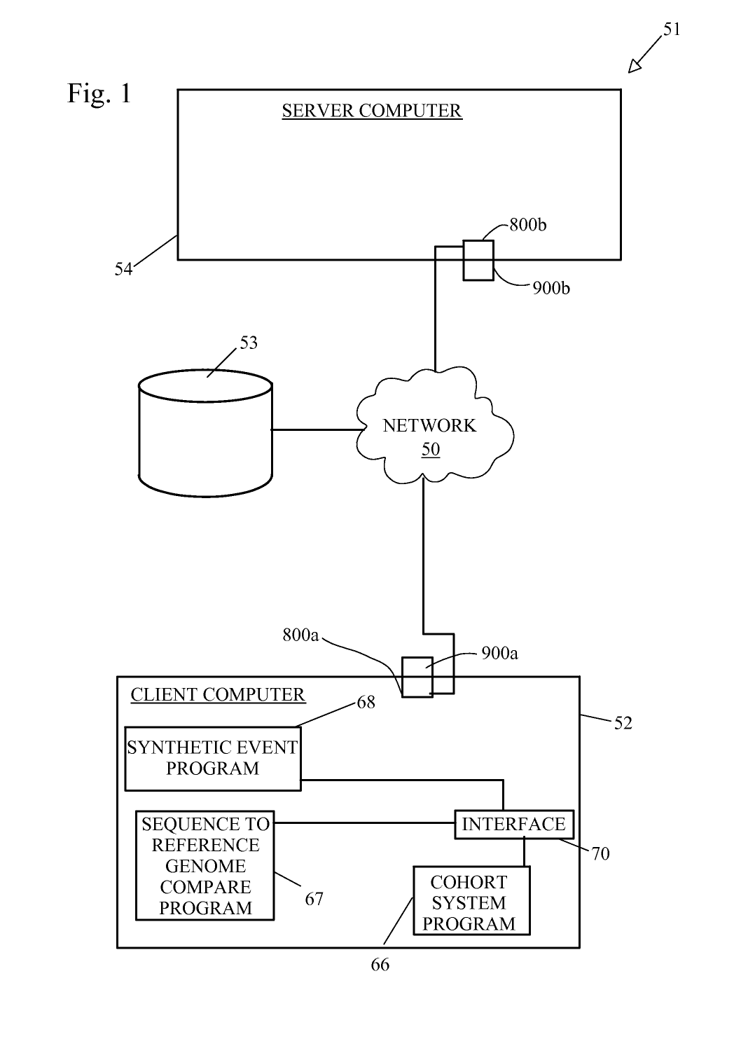

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wires, wireless communication links, or fiber optic cables.

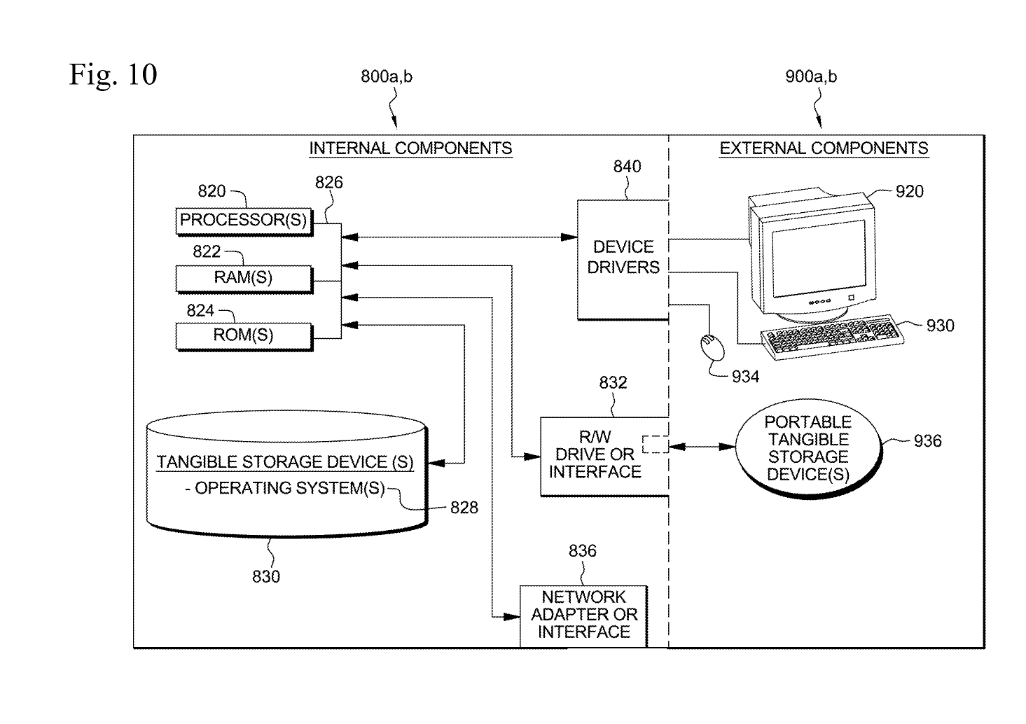

In the depicted example, a client computer 52, server computer 54, and a repository 53 connect to network 50. In other exemplary embodiments, network data processing system 51 may include additional client computers, storage devices, server computers, and other devices not shown. The client computer 52 includes a set of internal components 800a and a set of external components 900a, further illustrated in FIG. 10. The client computer 52 may be, for example, a mobile device, a cell phone, a personal digital assistant, a netbook, a laptop computer, a tablet computer, a desktop computer, a sequencing machine or any other type of computing device.

Client computer 52 may contain an interface 70. The interface can be, for example, a command line interface, a graphical user interface (GUI), or a web user interface (WUI). The interface may be used, for example for viewing a reference genome, genetic surprisal data, clusters, cohorts, and Kohonen feature maps. The interface may also accept an input of metadata regarding the synthetic events for example, a number of cohorts, a number of clusters, cluster size, density of the clusters, and the reference genome.

In the depicted example, server computer 54 provides information, such as boot files, operating system images, and applications to client computer 52. Server computer 54 can compute the information locally or extract the information from other computers on network 50. Server computer 54 includes a set of internal components 800b and a set of external components 900b illustrated in FIG. 10.

Program code, reference genomes, Kohonen maps, and programs such as a sequence to reference genome compare program 67, a cohort system program 66, and a synthetic event program 68 may be stored on at least one of one or more computer-readable tangible storage devices 830 shown in FIG. 10, on at least one of one or more portable computer-readable tangible storage devices 936 as shown in FIG. 10, or repository 53 connected to network 50, or downloaded to a data processing system or other device for use. For example, program code, reference genomes, Kohonen maps, a sequence to reference genome compare program 67, a cohort system program 66, and a synthetic event program 68 may be stored on at least one of one or more tangible storage devices 830 on server computer 54 and downloaded to client computer 52 over network 50 for use on client computer 52. Alternatively, server computer 54 can be a web server, and the program code, reference genomes, Kohonen maps, and programs such as a sequence to reference genome compare program 67, a cohort system program 66, and a synthetic event program 68 may be stored on at least one of the one or more tangible storage devices 830 on server computer 54 and accessed on client computer 52. Sequence to reference genome compare program 67, cohort system program 66, and synthetic event program 68 can be accessed on client computer 52 through interface 70. In other exemplary embodiments, the program code, reference genomes, Kohonen maps, and programs such as a sequence to reference genome compare program 67, a cohort system program 66, and a synthetic event program 68 may be stored on at least one of one or more computer-readable tangible storage devices 830 on client computer 52 or distributed between two or more servers.

In the depicted example, network data processing system 51 is a combination of a number of computers and servers, with network 50 representing the Internet—a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

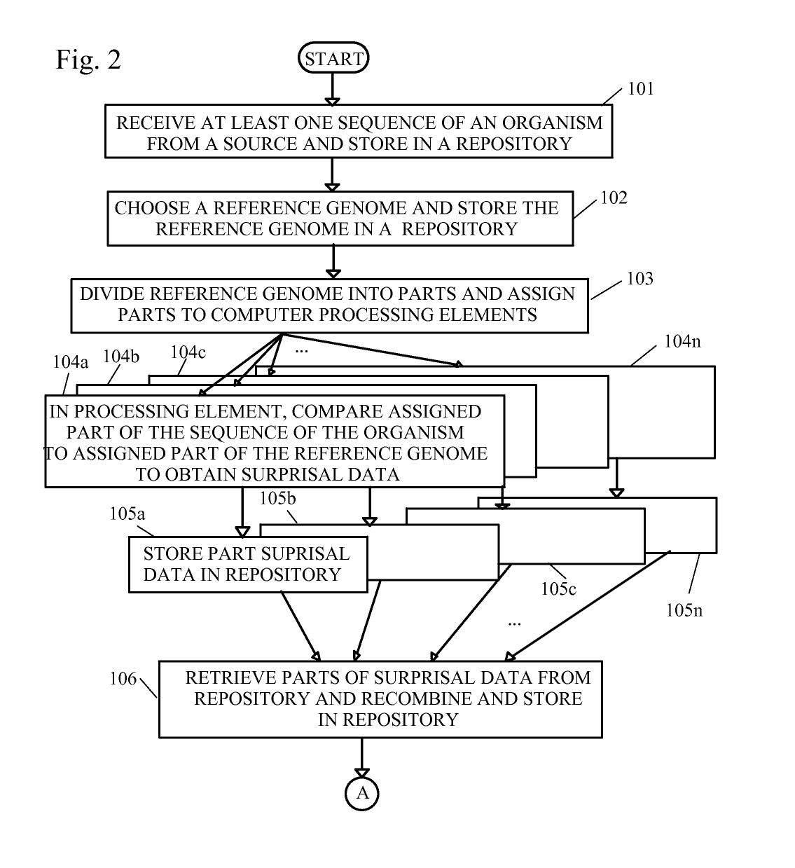

FIG. 2 shows a flowchart of a method of parallelization of surprisal data reduction of genetic data for transmission, storage, and analysis according to an illustrative embodiment.

In a first step, the sequence to reference genome compare program 67 receives at least one sequence of an organism from a source and stores the at least one sequence in a repository (step 101). The repository may be repository 53 as shown in FIG. 1. The source may be a sequencing device. The sequence may be a DNA sequence, an RNA sequence, or a nucleotide sequence. The organism may be a fungus, microorganism, human, animal or plant.

Based on the organism from which the at least one sequence is taken, the sequence to reference genome compare program 67 chooses and obtains at least one reference genome and stores the reference genome in a repository (step 102).

A reference genome is a digital nucleic acid sequence database which includes numerous sequences. The sequences of the reference genome do not represent any one specific individual's genome, but serve as a starting point for broad comparisons across a specific species, since the basic set of genes and genomic regulator regions that control the development and maintenance of the biological structure and processes are all essentially the same within a species. In other words, the reference genome is a representative example of a species' set of genes.

The reference genome may be tailored depending on the analysis that may take place after obtaining the surprisal data. For example, the sequence to reference genome compare program 67 can limit the comparison to specific genes of the reference genome, ignoring other genes or more common single nucleotide polymorphisms that may occur in specific populations of a species.

The sequence to reference genome compare program 67 divides the reference genome into parts and assigns at least one part of the reference genome to computer processing elements (step 103). For example, the reference genome may be divided into genes, with at least one gene being assigned to a separate computer processing element, such as a field programmable gate arrays (FPGA) or complex programmable logic devices (CPLD). The computer processing elements may be within the same computer or in separate computers which are connected by a network.

Within each computer processing element, the sequence to reference genome compare program 67 compares the at least one sequence to the part of reference genome to obtain surprisal data (step 104a-104n) and each computer processing element stores only the surprisal data in a repository 53 (step 105a-105n). It should be noted that steps referred to as a-n, includes steps a, b, c, until step n as takes place within the multiple computer processing elements.

The surprisal data is defined as at least one nucleotide difference that provides an “unexpected value” relative to the normally expected value of the reference genome sequence. In other words, the surprisal data contains at least one nucleotide difference present when comparing the sequence to the reference genome sequence. The surprisal data that is actually stored in the repository preferably includes a location of the difference within the reference genome, the number of nucleic acid bases that are different, and the actual changed nucleic acid bases. Storing the number of bases which are different provides a double check of the method by comparing the actual bases to the reference genome bases to confirm that the bases really are different.

The computer processing element controller determines whether the sequence of the organism was compared to all parts of the reference genome and may track the progress of assigned tasks through a time protocol or by when the assigned tasks are complete by the computer processing elements. Once tasks are completed by the computer processing elements, the computer processing element controller may distribute additional tasks to be completed.

The sequence to reference genome compare program 67 retrieves all parts of surprisal data from repository and recombines the parts of the surprisal data and stores the surprisal data in the repository (step 106).

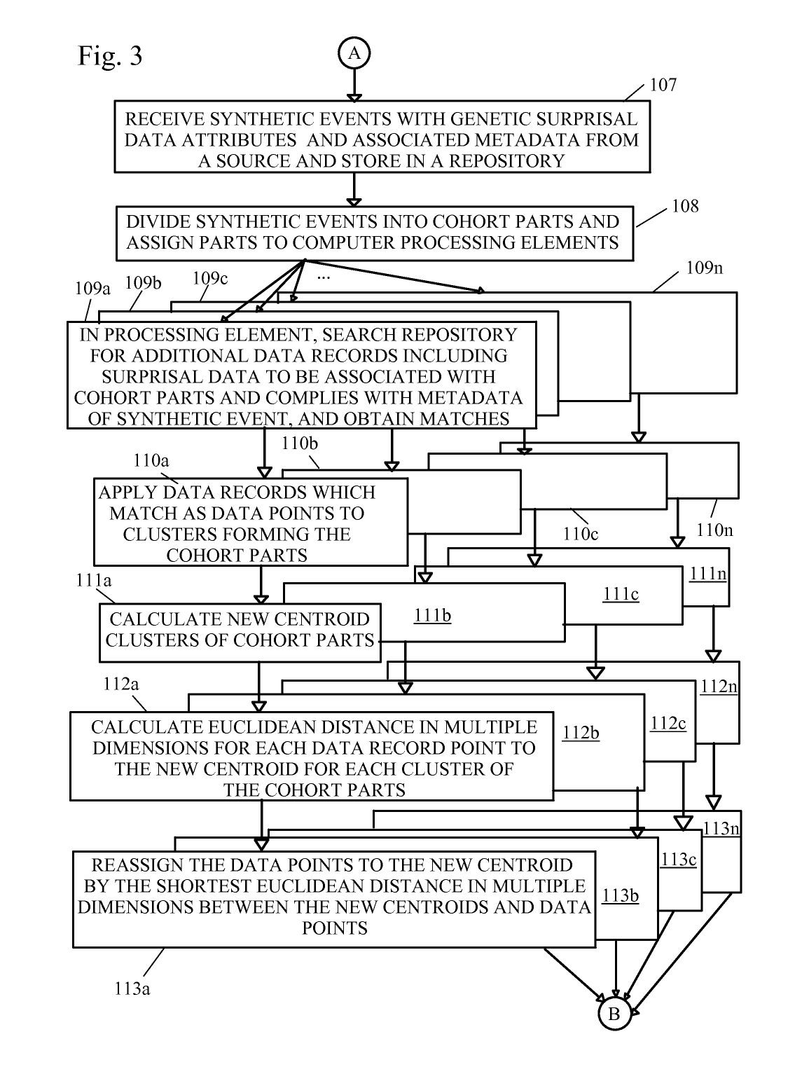

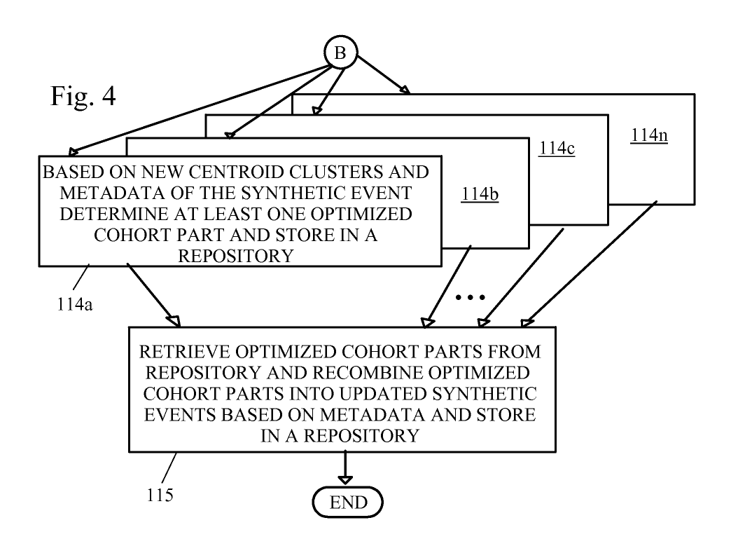

FIGS. 3-4 show a flowchart of a method of data parallelization of synthetic events with surprisal data attributes using genetic surprisal data representing a genetic sequence of an organism according to an illustrative embodiment. After genetic surprisal data has been generated, for example as shown in FIG. 2 through steps 101-106 or without the use of parallelization, the synthetic event program 68 receives synthetic events with genetic surprisal data attributes and their associated metadata and stores the synthetic event and associated metadata in a repository (step 107), for example repository 53 of FIG. 1. The metadata may include attributes of the synthetic event, for example specifics regarding the cohorts of the synthetic events and attributes of the clusters that form the cohorts. For example, cluster size, density of the cluster, and number of clusters.

The synthetic events are divided into cohort parts and at least one cohort part of the synthetic event is assigned to computer processing elements (step 108). For example, the synthetic event may be divided into cohort parts, with at least one cohort part being assigned to a separate computer processing element, such as a field programmable gate arrays (FPGA) or complex programmable logic devices (CPLD). The computer processing elements may be within the same computer or in separate computers which are connected by a network. Within each processing element, the cohort parts may be further divided into clusters.

Within each processing element, a repository of data records of patients is searched for example, by the synthetic event program 68, for additional data records of patients that include surprisal data that match or comply with the attributes of the metadata of the synthetic event and may be associated with the cohort parts (steps 109a-109n).

Within each processing element, data records which match are applied or assigned to centroid clusters as data points (steps 110a-110n), for example by the cohort system program 66 shown in FIG. 1. Once all of the data record matches have been assigned to centroid clusters first chosen, a new centroid is calculated for each cluster (steps 111a-111n), for example by the cohort system program 66.

The calculation of the new centroid cluster after all of the data points have been assigned typically moves the centroid and causes the assignment of the points to the cluster to now be inaccurate. So, within each processing element, a Euclidean distance in multiple dimensions is calculated for each data record match to the new centroids for each cluster of the at least one cohort part (steps 112a-112n). The data records are reassigned to the new centroid clusters by the shortest Euclidean distance in multiple dimensions between the new centroid clusters and the data points within each processing element (steps 113a-113n).

After steps 113a-113n of generating centroid clusters, within each processing element, at least one optimized cohort part with associated genetic surprisal data points from the clusters defined by metadata of the synthetic event is determined and stored in the repository (steps 114a-114n), for example repository 53. In a preferred embodiment, each processing element has a control cohort and a treatment cohort. In an alternative embodiment, each processing element may have only one cohort part, and in this case the cohort part, depending on whether it is a control cohort or a treatment cohort will be paired with an associated control cohort or treatment cohort back into a synthetic event.

The optimized cohort parts are retrieved from a repository and recombined based on metadata of the synthetic event, into an updated synthetic event associated with genetic surprisal data and stored in a repository (step 115), for example by the synthetic event program 68.

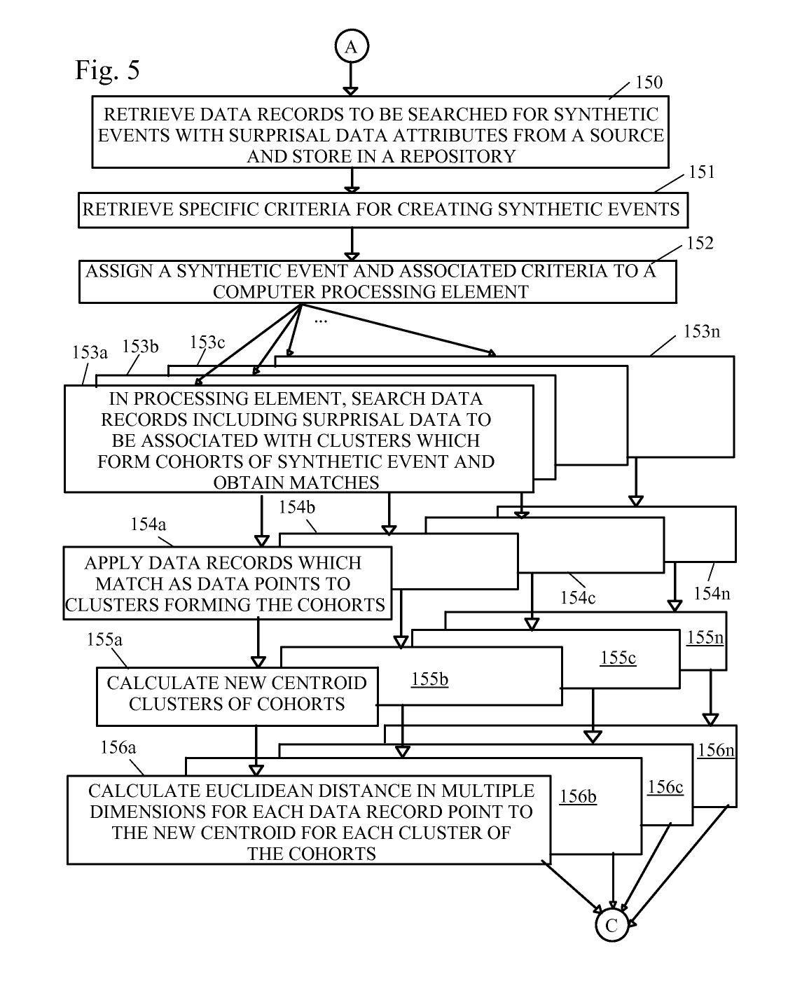

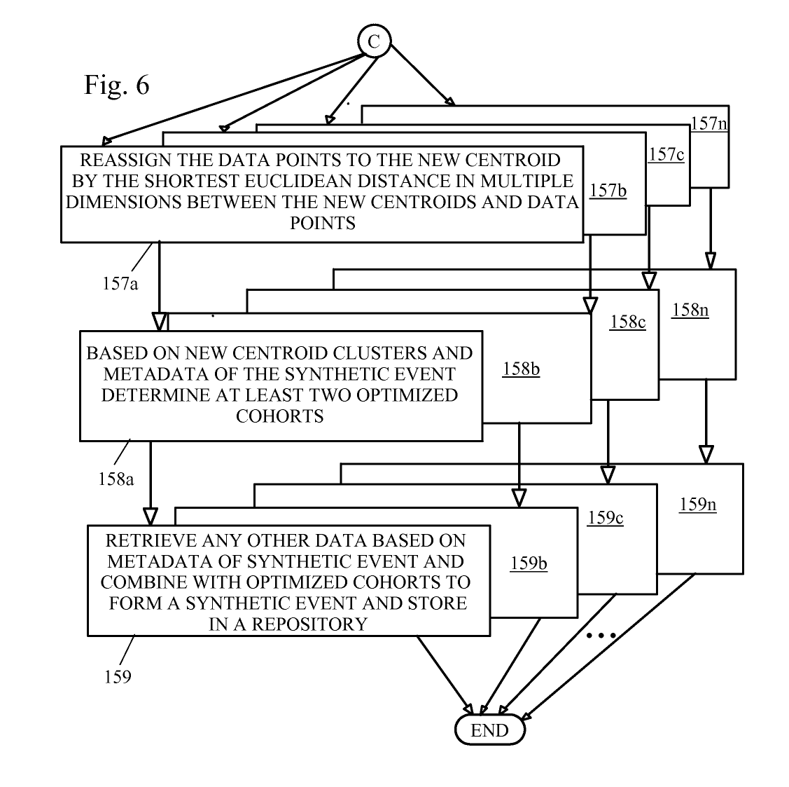

FIGS. 5-6 show a flowchart of a method of data parallelization of creating synthetic events with genetic surprisal data attributes using genetic surprisal data representing a genetic sequence of an organism according to an illustrative embodiment.

After genetic surprisal data has been generated, for example as shown in FIG. 2 through steps 101-106 or without the use of parallelization, the synthetic event program 68 retrieves data records to be searched, including data records with genetic surprisal data, for synthetic events and stores the data records in a repository, (step 150) for example repository 53 of FIG. 1. Next, specific metadata which includes criteria for creating a synthetic event is received from a user (step 151). The metadata may include attributes of the synthetic event, for example specifics regarding the cohorts of the synthetic events and attributes of the clusters that form the cohorts. For example, cluster size, density of the cluster, and number of clusters.

A synthetic event with its specific metadata regarding the criteria for creation of the synthetic event is assigned to a computer processing element (step 152). Since the cohorts of the synthetic event have not been created, the computer processing element constructs the entire synthetic event. For example, each synthetic event construction being assigned to a separate computer processing element, such as a field programmable gate arrays (FPGA) or complex programmable logic devices (CPLD). The computer processing elements may be within the same computer or in separate computers which are connected by a network.

Within each processing element, a repository of data records of patients is searched, for example by the synthetic event program 68, for data records of patients that match or comply with the metadata of the synthetic event and may be associated with the clusters, which form the cohorts of the synthetic event (steps 153a-153n). The data records preferably include genetic surprisal data.

Within each processing element, data records which match are assigned to or applied to centroid clusters as data points (steps 154a-154n), for example by the cohort system program 66 shown in FIG. 1. Once all of the data record matches have been assigned to centroid clusters first chosen, a new centroid is calculated for each cluster (steps 155a-155n), for example by the cohort system program 66.

The calculation of the new centroid cluster after all of the data points have been assigned typically moves the centroid and causes the assignment of the points to the cluster to now be inaccurate. So, within each processing element, a Euclidean distance in multiple dimensions is calculated for each data record match to the new centroids for each cluster which form cohorts of the synthetic event (steps 156a-156n). The data records are reassigned to the new centroid cluster by the shortest Euclidean distance in multiple dimensions between the new centroid clusters and the data points within each processing element (steps 157a-157n).

After steps 157a-157n of generating new centroid clusters, within each processing element, at least two optimized cohorts with associated genetic surprisal data points from the clusters defined by metadata of the synthetic event are determined and stored in the repository (steps 158a-158n), for example repository 53. The at least two optimized cohorts, preferably includes a treatment cohort and a control cohort.

Within each processing element, the at least two optimized cohorts and any other data as specified by the metadata associated with the synthetic event is retrieved and combined together to form a synthetic event, for example by the synthetic event program 68, and the synthetic event is stored in a repository, (steps 159a-159n) for example repository 53.

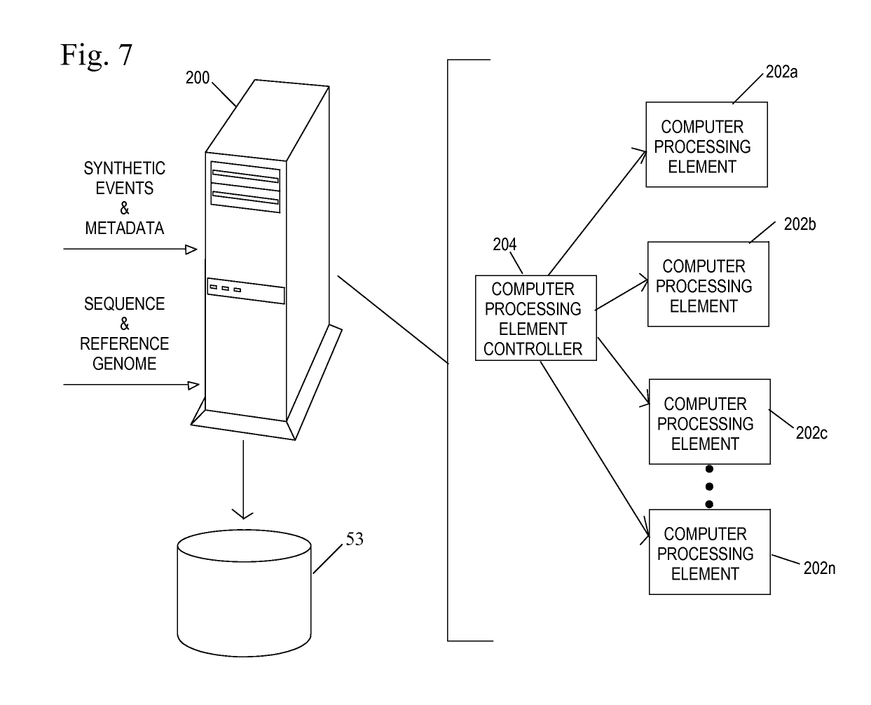

Referring to FIG. 7, a computer 200 receives a sequence from an organism and a reference genome and synthetic events with associated metadata. The computer 200 is in communication with a repository, for example repository 53. The computer 200 has numerous computer processing elements 202. A computer processing element controller 204 divides the reference genome into parts, preferably through the sequence to reference genome compare program 67 and assigns at least one part of the reference genome to the computer processing elements 202a-202n. Through the sequence to reference genome compare program 67, the computer processing elements 202a-202n compare the sequence to the parts of the reference genome to obtain surprisal data and stores only the surprisal data in a repository.

Similarly, the computer processing element controller 204 also divides synthetic events into cohort parts, preferably through synthetic event program 68 and assigns at least one cohort part of the synthetic event to the computer processing elements 202a-202n. Through the cohort system program 66, the computer processing elements 202a-202n optimize the clusters which form the cohort parts or cohorts to include data points with genetic surprisal data to obtain updated synthetic events with surprisal data and stores the updated synthetic events in a repository.

Alternatively, the computer processing element controller 204 also divides a group of synthetic events into individual synthetic events, preferably through synthetic event program 68 and assigns a synthetic event to the computer processing elements 202a-202n. Through the cohort system program 66, the computer processing elements 202a-202n forms clusters which form the cohort to include data points with genetic surprisal data to obtain a completed synthetic event and stores the synthetic event in a repository.

The computer processing element controller 204 tracks the progress of assigned tasks through a time protocol or by when the assigned tasks are complete by the computer processing elements 202a-202n. Once tasks are completed by the computer processing elements 202a-202n, the computer processing element controller 204 may distribute additional tasks to be completed.

By assigning genes of the reference genome to separate computer processing elements, the comparison of the at least one sequence to the genes comprising the reference genome to obtain surprisal data is executed in parallel across the separate computer processing elements, significantly decreasing the time necessary to obtain surprisal data.

Similarly, by assigning synthetic events, whether as a whole or by dividing the synthetic events into cohort pieces, to be assigned to separate computer processing elements, the generation of synthetic events or updating of synthetic events is executed in parallel across the separate computer processing elements, significantly decreasing the time necessary to generate synthetic events.

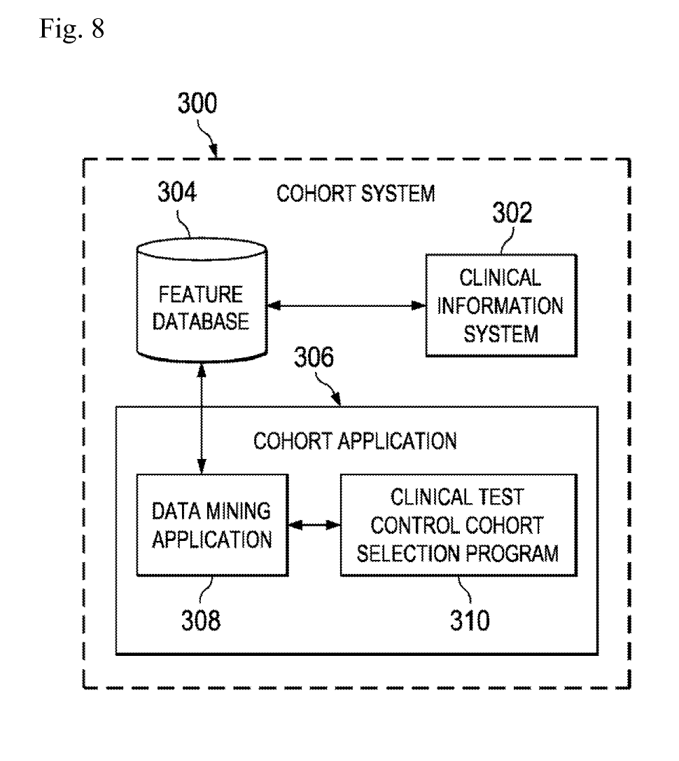

FIG. 8 shows a block diagram of a system for generating genetic surprisal data control cohorts in accordance with an illustrative embodiment. Cohort system 300 is a system for generating surprisal data cohorts, including control cohorts and may use cohort system program 66 as shown in FIG. 1 to control and operate the cohort system and its associated elements and programs. Cohort system 300 includes clinical information system (CIS) 302, feature database 304, and cohort application 306. Each component of cohort system 300 may be interconnected via a network, such as network 50 of FIG. 1. Cohort application 306 further includes data mining application 308 and clinical test control cohort selection program 310.

Clinical information system 302 is a management system for managing patient data. This data may include, for example, family health history data, vital signs, laboratory test results, drug treatment history, admission-discharge-treatment (ADT) records, co-morbidities, modality images, genetic data, surprisal genetic data, and other patient data. Clinical information system 302 may be executed by a computing device, such as server computer 54 or client computer 52 of FIG. 1. Clinical information system 302 may also include information about a population of patients as a whole. Such information may disclose patients who have agreed to participate in medical research but who are not participants in a current study. Clinical information system 302 includes medical records for acquisition, storage, manipulation, and distribution of clinical information for individuals and organizations. Clinical information system 302 is scalable, allowing information to expand as needed. Clinical information system 302 may also include information sourced from pre-existing systems, such as pharmacy management systems, laboratory management systems, and radiology management systems.

Feature database 304 is a database in a repository, such as repository 53 of FIG. 1. Feature database 304 is populated with data from clinical information system 302. Feature database 304 includes patient data in the form of attributes. Attributes define features, variables, and characteristics of each patient. Attributes may be associated with specific parameters set by the user. The most common attributes may include gender, age, disease or illness, and state of the disease. These attributes may be used in steps 109a-109n and 110a-110n of FIG. 3 and steps 153a-153n and 154a-154n of FIG. 5 when searching the population for matches to metadata of the synthetic event or set by a user.

Cohort application 306 is a program for selecting control cohorts. Cohort application 306 is executed by a computing device, such as server computer 54 or client computer 52 of FIG. 1. Data mining application 308 is a program that provides data mining functionality on feature database 304 and other interconnected databases. In one example, data mining application 308 may be a program, such as DB2 Intelligent Miner produced by International Business Machines Corporation. Data mining is the process of automatically searching large volumes of data for patterns. Data mining may be further defined as the nontrivial extraction of implicit, previously unknown, and potentially useful information from data. Data mining application 308 uses computational techniques from statistics, information theory, machine learning, and pattern recognition.

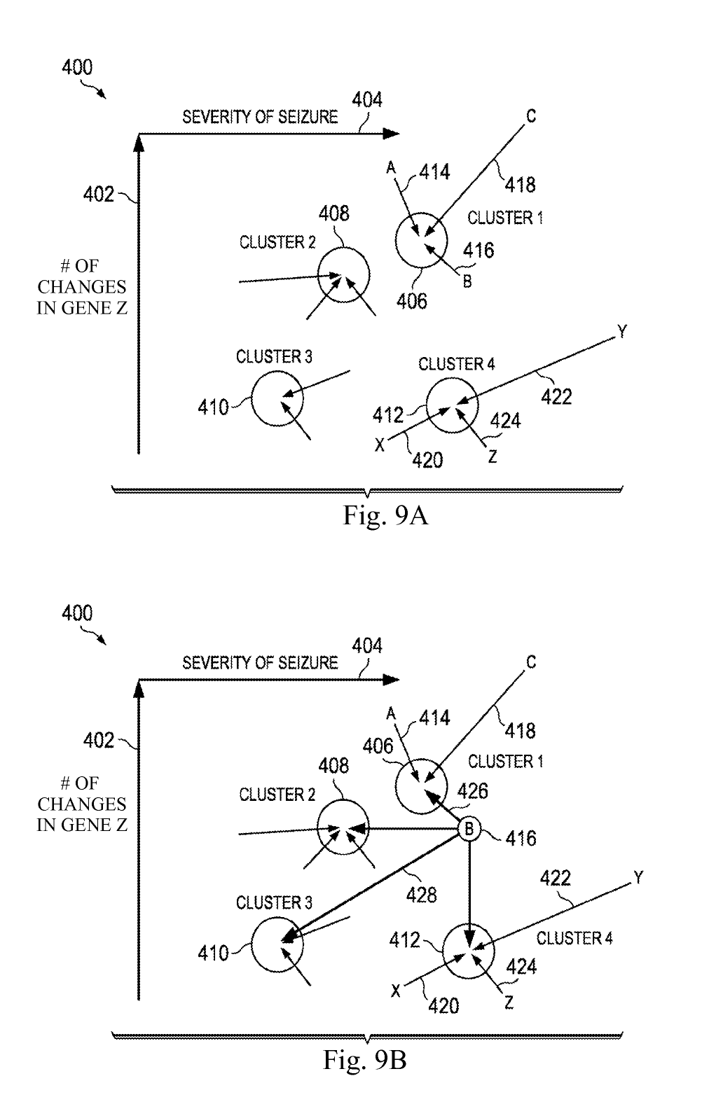

Particularly, data mining application 308 extracts useful information from feature database 304. Data mining application 308 allows users to select data, analyze data, show patterns, sort data, determine relationships, and generate statistics. Data mining application 308 may be used to cluster records in feature database 304 based on specified metadata which may include attributes to generate centroid clusters and may be used to implement step 111a-111n of FIG. 3 and step 155a-155n of FIG. 5. Data mining application 308 searches the records for attributes set by the user, and groups the related records or members accordingly for display or analysis to the user. This grouping process is referred to as clustering. The results of clustering show the number of detected clusters and the attributes that make up each cluster. Clustering is further described with respect to FIGS. 9A and 9B.

For example, data mining application 308 may be able to group patient records to show the effect of a new sepsis blood infection medicine. Currently, about 35 percent of all patients with the diagnosis of sepsis die. Patients entering an emergency department of a hospital who receive a diagnosis of sepsis, and who are not responding to classical treatments, may be recruited to participate in a drug trial. A statistical control cohort of similarly ill patients could be developed by cohort system 300, using records from historical patients, patients from another similar hospital, and patients who choose not to participate. Potential features to produce a clustering model could include age, co-morbidities, gender, surgical procedures, number of days of current hospitalization, O₂ blood saturation, blood pH, blood lactose levels, bilirubin levels, blood pressure, respiration, mental acuity tests, genetic surprisal data, and urine output.

Data mining application 308 may use a clustering technique or model known as a Kohonen feature map neural network or neural clustering. Kohonen feature maps specify a number of clusters and the maximum number of passes through the data, for example provided by the input in step 107 of FIG. 3 and the input from the user in step 151 of FIG. 5. The number of clusters must be between one and the number of records in the treatment cohort. The greater the number of clusters, the better the comparisons can be made between the treatment and the control cohort. Clusters are natural groupings of patient records based on the specified features, parameters or attributes. For example, a user may request that data mining application 308 generate eight clusters in a maximum of ten passes. The main task of neural clustering is to find a center or centroid for each cluster. The centroid is also called the cluster prototype. Scores are generated based on the distance between each patient record and each of the cluster prototypes. Scores closer to zero have a higher degree of similarity to the cluster prototype. The higher the score, the more dissimilar the record is from the cluster prototype.

All inputs to a Kohonen feature map must be scaled from 0.0 to 1.0. In addition, categorical values must be converted into numeric codes for presentation to the neural network. Conversions may be made by methods that retain the ordinal order of the input data, such as discrete step functions or bucketing of values. Each record is assigned to a single cluster, but by using data mining application 308, a user may determine a record's Euclidean dimensional distance for all cluster prototypes, as in step 112a-112n of FIG. 3 and step 156a-156n of FIG. 5. Clustering is performed for the treatment cohort. Clinical test control cohort selection program 310 minimizes the sum of the Euclidean distances between the individuals or members in the treatment cohorts and the control cohort, as also described in step 113a-113n of FIG. 3 and step 157a-157n of FIG. 5. Clinical test control cohort selection program 310 may incorporate an integer programming model. This program may be programmed in International Business Machine Corporation products, such as Mathematical Programming System eXtended (MPSX), the IBM Optimization Subroutine Library, or the open source GNU Linear Programming Kit. The illustrative embodiments minimize the summation of all records/cluster prototype Euclidean distances from the potential control cohort members to select the optimum control cohort.

FIGS. 9A-9B are graphical illustrations of clustering in accordance with an illustrative embodiment. Feature map 400 of FIG. 9A is a self-organizing map (SOM) and is a subtype of artificial neural networks. Feature map 400 is trained using unsupervised learning to produce a low-dimensional representation of the training samples while preserving the topological properties of the input space. This makes feature map 400 especially useful for visualizing high-dimensional data, including cohorts and clusters.

In one illustrative embodiment, feature map 400 is a Kohonen Feature Map neural network. Feature map 400 uses a process called self-organization to group similar patient records together. Feature map 400 may use various dimensions. In this example, feature map 400 is a two-dimensional feature map including number of changes to gene z (e.g. genetic surprisal data) 402 and severity of seizure 404. Feature map 400 may include as many dimensions as there are features, such as age, gender, and severity of illness. Feature map 400 also includes cluster 1 406, cluster 2 408, cluster 3 410, and cluster 4 412. The clusters are the result of using feature map 400 to group individual patients based on the features. The clusters are self-grouped local estimates of all data or patients being analyzed based on competitive learning. When a training sample of patients is analyzed by data mining application 308 of FIG. 8, each patient is grouped into clusters where the clusters are weighted functions that best represent natural divisions of all patients based on the specified features.

The user may choose to specify the number of clusters and the maximum number of passes through the data. These parameters control the processing time and the degree of granularity used when patient records are assigned to clusters. The primary task of neural clustering is to find a center or centroid for each cluster. The centroid is also called the cluster prototype. For each record in the input patient data set, the neural clustering data mining program computes the cluster prototype that is the closest to the records. For example, patient record A 414, patient record B 416, and patient record C 418 are grouped into cluster 1 406. Additionally, patient record X 420, patient record Y 422, and patient record Z 424 are grouped into cluster 4 412.

FIG. 9B further illustrates how the score for each data record is represented by the Euclidean distance from the cluster prototype. The higher the score, the more dissimilar the record is from the particular cluster prototype. With each pass over the input patient data, the centers are adjusted so that a better quality of the overall clustering model is reached. To score a potential control cohort for each patient record, the Euclidian distance is calculated from each cluster prototype. This score is passed along to an integer programming system in clinical test control cohort selection program 310 of FIG. 8.

For example, patient B 416 is scored into the cluster prototype or center of cluster 1 406, cluster 2 408, cluster 3 410 and cluster 4 412. A Euclidean distance between patient B 416 and cluster 1 406, cluster 2 408, cluster 3 410 and cluster 4 412 is shown. In this example, distance 1 426, separating patient B 416 from cluster 1 406, is the closest. Distance 3 428, separating patient B 416 from cluster 3 410, is the furthest. These distances indicate that cluster 1 406 is the best fit.

FIG. 10 illustrates internal and external components of client computer 52 and server computer 54 in which illustrative embodiments may be implemented. In FIG. 10, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, a sequence to reference genome compare program 67, a cohort system program 66, and a synthetic event program 68 are stored on one or more of the computer-readable tangible storage devices 830 for execution by one or more of the processors 820 via one or more of the RAMs 822 (which typically include cache memory). In the embodiment illustrated in FIG. 10, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Sequence to reference genome compare program 67, cohort system program 66, and synthetic event program 68 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Sequence to reference genome compare program 67, cohort system program 66, and synthetic event program 68 can be downloaded to client computer 52 and server computer 54 from an external computer via a network (for example, the Internet, a local area network or other, wide area network) and network adapter or interface 836. From the network adapter or interface 836, a sequence to reference genome compare program 67, a cohort system program 66, and a synthetic event program 68 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Sequence to reference genome compare program 67, cohort system program 66, and synthetic event program 68 can be written in various programming languages including low-level, high-level, object-oriented or non object-oriented languages. Alternatively, the functions of a sequence to reference genome compare program 67, a cohort system program 66, and a synthetic event program 68 can be implemented in whole or in part by computer circuits and other hardware (not shown).

Based on the foregoing, a computer system, method and program product have been disclosed for parallelization of updating synthetic events with genetic surprisal data representing a genetic sequence of an organism and parallelization of creating synthetic events with genetic surprisal data representing a genetic sequence of an organism. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of parallelization of updating synthetic events with genetic surprisal data representing a genetic sequence of an organism comprising:
a computer receiving a synthetic event and associated metadata from a user, wherein the metadata comprises at least one genetic surprisal data attribute;
the computer dividing the synthetic event into cohort parts and assigning the cohort parts and associated synthetic event metadata to one of the plurality of computer processing elements; and
within each processing element:
searching data records of patients for genetic surprisal data and storing matches of the data records in a repository;
generating a cluster comprising a centroid by populating the cluster based on all of the matches of the data records;
calculating a new centroid for each cluster;
calculating a Euclidean distance in multiple dimensions for each match of data records to the new centroid for each cluster;
reassigning each match of data to the new centroid of each cluster based on the shortest calculated Euclidean distance to the new centroid for each cluster; and
determining at least one cohort part, a control cohort or a treatment cohort, from the clusters, and based on the associated metadata from the user and storing the at least one cohort part in a repository;
the computer retrieving the cohort parts from the repository and recombining the cohort parts into updated synthetic events based on the metadata and storing the updated synthetic events in the repository.

2. The method of claim 1, further comprising before the step of the computer receiving a synthetic event and associated metadata from a user:
the computer dividing a reference genome and the genetic sequence of the organism into parts and assigning each of the parts of the reference genome and the parts of the genetic sequence of the organism to one of the plurality of computer processing elements;
within each computer processing element, comparing the nucleotides of the assigned part of the genetic sequence of the organism to nucleotides of the assigned part of the reference genome, to find differences where nucleotides of the genetic sequence of the organism are different from the nucleotides of the assigned part of the reference genome, and storing surprisal data in a repository, the surprisal data comprising at least a starting location of the differences within the assigned part of the reference genome, and the nucleotides from the genetic sequence of the organism which are different from the nucleotides of the assigned part of the reference genome, discarding sequences of nucleotides that are the same in the genetic sequence of the organism and the assigned part of the reference genome;
the computer retrieving the parts of the surprisal data from the repository;
the computer combining the parts of the surprisal data from the repository to form a complete set of surprisal data representing the differences between the genetic sequence of the organism and the reference genome; and
the computer storing the complete set of surprisal data in the repository.

3. The method of claim 1, wherein the step of the computer processing element searching data records of a patient for genetic surprisal data and storing matches of the data records is performed by a data mining application.

4. The method of claim 1, wherein the step of the computer processing element determining at least one cohort part, a control cohort or a treatment cohort, from the clusters and, based on the associated metadata from the user storing the at least one cohort part in a repository further comprises: generating a feature map to form treatment cohorts.

5. The method of claim 4, wherein the feature map is a Kohonen feature map.

6. A method of parallelization of creating synthetic events with genetic surprisal data representing a genetic sequence of an organism comprising:
a computer retrieving data records of patients to be searched for synthetic events;
the computer receiving a plurality of synthetic events and associated metadata from a user, wherein the metadata comprises at least one genetic surprisal data attribute; and
the computer dividing the plurality of synthetic events into single synthetic events and assigning the single synthetic event and associated synthetic event metadata to one of the plurality of computer processing elements;
within each processing element:
searching data records of patients for genetic surprisal data and storing matches of the data records in a repository;
generating a cluster comprising a centroid by populating the cluster based on all of the matches of the data records;
calculating a new centroid for each cluster;
calculating a Euclidean distance in multiple dimensions for each match of data records to the new centroid for each cluster;
reassigning each match of data to the new centroid of each cluster based on the shortest calculated Euclidean distance to the new centroid for each cluster;
determining at least two cohorts, a control cohort and a treatment cohort, from the clusters, and based on the associated metadata from the user and storing the at least two cohorts in a repository; and
retrieving any other data based on the associated metadata of the synthetic event and combining the other data retrieved with the at least two cohorts to form a synthetic event and storing the synthetic event in the repository.

7. The method of claim 6, further comprising before the step of the retrieving data records of patients to be searched for synthetic events:
the computer dividing a reference genome and the genetic sequence of the organism into parts and assigning each of the parts of the reference genome and the parts of the genetic sequence of the organism to one of the plurality of computer processing elements;
within each computer processing element, comparing the nucleotides of the assigned part of the genetic sequence of the organism to nucleotides of the assigned part of the reference genome, to find differences where nucleotides of the genetic sequence of the organism are different from the nucleotides of the assigned part of the reference genome, and storing surprisal data in a repository, the surprisal data comprising at least a starting location of the differences within the assigned part of the reference genome, and the nucleotides from the genetic sequence of the organism which are different from the nucleotides of the assigned part of the reference genome, discarding sequences of nucleotides that are the same in the genetic sequence of the organism and the assigned part of the reference genome;
the computer retrieving the parts of the surprisal data from the repository;
the computer combining the parts of the surprisal data from the repository to form a complete set of surprisal data representing the differences between the genetic sequence of the organism and the reference genome; and
the computer storing the complete set of surprisal data in the repository.

8. The method of claim 6, wherein the step of the computer processing element searching data records of a patient for genetic surprisal data and storing matches of the data records is performed by a data mining application.

9. The method of claim 1, wherein the step of the computer processing element determining at least two cohorts, a control cohort and a treatment cohort, from the clusters and, based on the associated metadata from the user, storing the at least two cohorts in a repository, further comprises generating a feature map to form treatment cohorts.

10. The method of claim 9, wherein the feature map is a Kohonen feature map.

11. A computer program product for parallelization of updating synthetic events with genetic surprisal data representing a genetic sequence of an organism comprising:
one or more computer-readable, tangible storage devices;
program instructions, stored on at least one of the one or more storage devices, to receive a synthetic event and associated metadata from a user, wherein the metadata comprises at least one genetic surprisal data attribute;
program instructions, stored on at least one of the one or more storage devices, to divide the synthetic event into cohort parts and assign the cohort parts and associated synthetic event metadata to one of the plurality of computer processing elements; and
within each processing element, program instructions, stored on at least one of the one or more storage devices, to:
search data records of patients for genetic surprisal data and store matches of the data records in a repository;
generate a cluster comprising a centroid by populating the cluster based on all of the matches of the data records;
calculate a new centroid for each cluster;
calculate a Euclidean distance in multiple dimensions for each match of data records to the new centroid for each cluster;
reassign each match of data to the new centroid of each cluster based on the shortest calculated Euclidean distance to the new centroid for each cluster; and
determine at least one cohort part, a control cohort or a treatment cohort, from the clusters, and based on the associated metadata from the user and store the at least one cohort part in a repository;
program instructions, stored on at least one of the one or more storage devices, to retrieve the cohort parts from the repository and recombine the cohort parts into updated synthetic events based on the metadata and store the updated synthetic events in the repository.

12. The computer program product of claim 11, further comprising before the program instructions, stored on at least one of the one or more storage devices, to receive a synthetic event and associated metadata from a user:
program instructions, stored on at least one of the one or more storage devices, to divide a reference genome and the genetic sequence of the organism into parts and assign each of the parts of the reference genome and the parts of the genetic sequence of the organism to one of the plurality of computer processing elements;
within each computer processing element, program instructions, stored on at least one of the one or more storage devices, to compare the nucleotides of the assigned part of the genetic sequence of the organism to nucleotides of the assigned part of the reference genome, to find differences where nucleotides of the genetic sequence of the organism are different from the nucleotides of the assigned part of the reference genome, and store surprisal data in a repository, the surprisal data comprising at least a starting location of the differences within the assigned part of the reference genome, and the nucleotides from the genetic sequence of the organism which are different from the nucleotides of the assigned part of the reference genome, discarding sequences of nucleotides that are the same in the genetic sequence of the organism and the assigned part of the reference genome;
program instructions, stored on at least one of the one or more storage devices, to retrieve the parts of the surprisal data from the repository;
program instructions, stored on at least one of the one or more storage devices, to combine the parts of the surprisal data from the repository to form a complete set of surprisal data representing the differences between the genetic sequence of the organism and the reference genome; and
program instructions, stored on at least one of the one or more storage devices, to store the complete set of surprisal data in the repository.

13. The computer program product of claim 11, wherein the computer processing element program instructions, stored on at least one of the one or more storage devices, to search data records of a patient for genetic surprisal data and store matches of the data records is performed by a data mining application.

14. The computer program product of claim 11, wherein the computer processing element program instructions, stored on at least one of the one or more storage devices, to determine at least one cohort part, a control cohort or a treatment cohort, from the clusters and, based on the associated metadata from the user store the at least one cohort part in a repository further comprises: program instructions, stored on at least one of the one or more storage devices, to generate a feature map to form treatment cohorts.

15. The computer program product of claim 14, wherein the feature map is a Kohonen feature map.

16. A computer program product for parallelization of creating synthetic events with genetic surprisal data representing a genetic sequence of an organism comprising:
program instructions, stored on at least one of the one or more storage devices, to retrieve data records of patients to be searched for synthetic events;
program instructions, stored on at least one of the one or more storage devices, to receive a plurality of synthetic events and associated metadata from a user, wherein the metadata comprises at least one genetic surprisal data attribute; and
program instructions, stored on at least one of the one or more storage devices, to divide the plurality of synthetic events into single synthetic events and assign the single synthetic event and associated synthetic event metadata to one of the plurality of computer processing elements;
within each processing element, program instructions, stored on at least one of the one or more storage devices, to:
search data records of patients for genetic surprisal data and store matches of the data records in a repository;
generate a cluster comprising a centroid by populating the cluster based on all of the matches of the data records;
calculate a new centroid for each cluster;
calculate a Euclidean distance in multiple dimensions for each match of data records to the new centroid for each cluster;
reassign each match of data to the new centroid of each cluster based on the shortest calculated Euclidean distance to the new centroid for each cluster;
determine at least two cohorts, a control cohort and a treatment cohort, from the clusters, and based on the associated metadata from the user and store the at least two cohorts in a repository; and
retrieve any other data based on the associated metadata of the synthetic event and combine the other data retrieved with the at least two cohorts to form a synthetic event and store the synthetic event in the repository.

17. A system for parallelization of updating synthetic events with genetic surprisal data representing a genetic sequence of an organism comprising:
one or more processors, one or more computer-readable memories and one or more computer-readable, tangible storage devices;
program instructions, stored on at least one of the one or more storage devices for execution by at least one of the one or more processors via at least one of the one or more memories, to receive a synthetic event and associated metadata from a user, wherein the metadata comprises at least one genetic surprisal data attribute;
program instructions, stored on at least one of the one or more storage devices for execution by at least one of the one or more processors via at least one of the one or more memories, to divide the synthetic event into cohort parts and assign the cohort parts and associated synthetic event metadata to one of the plurality of computer processing elements; and
within each processing element, program instructions, stored on at least one of the one or more storage devices for execution by at least one of the one or more processors via at least one of the one or more memories, to:
search data records of patients for genetic surprisal data and store matches of the data records in a repository;
generate a cluster comprising a centroid by populating the cluster based on all of the matches of the data records;
calculate a new centroid for each cluster;
calculate a Euclidean distance in multiple dimensions for each match of data records to the new centroid for each cluster;
reassign each match of data to the new centroid of each cluster based on the shortest calculated Euclidean distance to the new centroid for each cluster; and
determine at least one cohort part, a control cohort or a treatment cohort, from the clusters, and based on the associated metadata from the user and store the at least one cohort part in a repository;
program instructions, stored on at least one of the one or more storage devices for execution by at least one of the one or more processors via at least one of the one or more memories, to retrieve the cohort parts from the repository and recombine the cohort parts into updated synthetic events based on the metadata and store the updated synthetic events in the repository.

18. The system of claim 17, further comprising before the program instructions, stored on at least one of the one or more storage devices for execution by at least one of the one or more processors via at least one of the one or more memories, to receive a synthetic event and associated metadata from a user:
program instructions, stored on at least one of the one or more storage devices for execution by at least one of the one or more processors via at least one of the one or more memories, to divide a reference genome and the genetic sequence of the organism into parts and assign each of the parts of the reference genome and the parts of the genetic sequence of the organism to one of the plurality of computer processing elements;
within each computer processing element, program instructions, stored on at least one of the one or more storage devices for execution by at least one of the one or more processors via at least one of the one or more memories, to compare the nucleotides of the assigned part of the genetic sequence of the organism to nucleotides of the assigned part of the reference genome, to find differences where nucleotides of the genetic sequence of the organism are different from the nucleotides of the assigned part of the reference genome, and store surprisal data in a repository, the surprisal data comprising at least a starting location of the differences within the assigned part of the reference genome, and the nucleotides from the genetic sequence of the organism which are different from the nucleotides of the assigned part of the reference genome, discarding sequences of nucleotides that are the same in the genetic sequence of the organism and the assigned part of the reference genome;
program instructions, stored on at least one of the one or more storage devices for execution by at least one of the one or more processors via at least one of the one or more memories, to retrieve the parts of the surprisal data from the repository;
program instructions, stored on at least one of the one or more storage devices for execution by at least one of the one or more processors via at least one of the one or more memories, to combine the parts of the surprisal data from the repository to form a complete set of surprisal data representing the differences between the genetic sequence of the organism and the reference genome; and
program instructions, stored on at least one of the one or more storage devices for execution by at least one of the one or more processors via at least one of the one or more memories, to store the complete set of surprisal data in the repository.

19. The system of claim 17, wherein the computer processing element program instructions, stored on at least one of the one or more storage devices for execution by at least one of the one or more processors via at least one of the one or more memories, to search data records of a patient for genetic surprisal data and store matches of the data records is performed by a data mining application.

20. The system of claim 17, wherein the computer processing element program instructions, stored on at least one of the one or more storage devices for execution by at least one of the one or more processors via at least one of the one or more memories, to determine at least one cohort part, a control cohort or a treatment cohort, from the clusters and, based on the associated metadata from the user store the at least one cohort part in a repository further comprises: program instructions, stored on at least one of the one or more storage devices, to generate a feature map to form treatment cohorts.

21. The system of claim 20, wherein the feature map is a Kohonen feature map.

22. A system for parallelization of creating synthetic events with genetic surprisal data representing a genetic sequence of an organism comprising:
program instructions, stored on at least one of the one or more storage devices for execution by at least one of the one or more processors via at least one of the one or more memories, to retrieve data records of patients to be searched for synthetic events;
program instructions, stored on at least one of the one or more storage devices for execution by at least one of the one or more processors via at least one of the one or more memories, to receive a plurality of synthetic events and associated metadata from a user, wherein the metadata comprises at least one genetic surprisal data attribute; and
program instructions, stored on at least one of the one or more storage devices for execution by at least one of the one or more processors via at least one of the one or more memories, to divide the plurality of synthetic events into single synthetic events and assign the single synthetic event and associated synthetic event metadata to one of the plurality of computer processing elements;
within each processing element, program instructions, stored on at least one of the one or more storage devices for execution by at least one of the one or more processors via at least one of the one or more memories, to:
search data records of patients for genetic surprisal data and store matches of the data records in a repository;
generate a cluster comprising a centroid by populating the cluster based on all of the matches of the data records;
calculate a new centroid for each cluster;
calculate a Euclidean distance in multiple dimensions for each match of data records to the new centroid for each cluster;
reassign each match of data to the new centroid of each cluster based on the shortest calculated Euclidean distance to the new centroid for each cluster;
determine at least two cohorts, a control cohort and a treatment cohort, from the clusters, and based on the associated metadata from the user and store the at least two cohorts in a repository; and
retrieve any other data based on the associated metadata of the synthetic event and combine the other data retrieved with the at least two cohorts to form a synthetic event and store the synthetic event in the repository.
